(19) United States
(12) Patent Application Publication
(10) Pub. No.: US 2026/0209545 A1
(43) Pub. Date: Jul. 23, 2026

(54) CROSSLINKABLE COATING SYSTEM AND COATINGS PREPARED FROM THE SAME

(71) Applicant: SWIMC LLC, Cleveland, OH (US)

(72) Inventors: Matthieu ANDRIOT, Attignat (FR); Sébastien GIBANEL, Givry (FR); Mélissa MICHAELI, Tournus (FR); Adeline GEOFFROY, Sornay (FR)

(21) Appl. No.: 19/139,145

(22) PCT Filed: Dec. 15, 2023
(86) PCT No.: PCT/US2023/084307

§ 371 Date: Jun. 13, 2025

Related U.S. Application Data
(60) Provisional application No. 63/433,268, filed on Dec. 16, 2022.

(51) Int. Cl. C09D 161/22; C08G 12/22; C09D 5/03

(52) U.S. Cl. CPC C09D 161/22; C08G 12/22; C09D 5/03

(57) ABSTRACT

Crosslinkable coating systems, methods of coating articles with the crosslinkable coating systems, and articles coated with the same are provided. The coating system includes an amide and an aldehyde comprising two or more carbon atoms. The coating system may include a solvent. The coating system may be free or substantially free of formaldehyde and isocyanate. The coating system may include a reaction product of an amide and an aldehyde comprising two or more carbon atoms. The coating system may be in powder form.

### SUMMARY

The present disclosure broadly relates to crosslinkable coating systems. The present disclosure further relates to methods of coating articles with the crosslinkable coating systems and to articles coated with the same.

In some embodiments, a coating system includes an amide component including a primary amide, an aldehyde including two or more carbon atoms; and a solvent. The amide component may be present at a molar ratio of 0.5 to 2.5 moles for every 1 mole of the aldehyde.

The amide component may be represented by Formula (I):

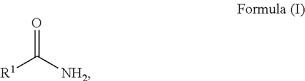

wherein R¹ is H or a carbon-containing group, optionally further substituted with one or more oxygen, nitrogen, or sulfur atoms or a combination thereof, preferably where R¹ is H or an alkyl, aryl, acyl, acrylate, carboxylic acid, urethane, ester, carbonate, alkenyl, alkynyl, alkoxy, alcohol, amine, alkylamine, methacrylate, acrylamide, methacrylamide, vinyl, phenol, ketone, urea, or amide group.

The amide component may include a diamide, triamide, or polyamide.

The aldehyde may be represented by Formula (11) or (IIB):

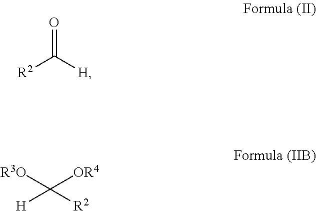

wherein R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, optionally wherein the aldehyde is in a protected form including an acetal or a hydrate. And where each R³ and R⁴ are independently a carbon-containing group, optionally further substituted with one or more oxygen, nitrogen, or sulfur atoms or a combination thereof, preferably where each R¹ and R⁴ are independently an alkyl, aryl, acyl, acrylate, carboxylic acid, urethane, ester, amide, carbonate, alkenyl, alkynyl, alkoxy, alcohol, amine, methacrylate, acrylamide, methacrylamide, vinyl, phenol, ketone, alkylamine, or urea group. Each R³ and R⁴ may independently be straight, branched, or cyclic, and may include zero, one, or more double bonds. Each R¹ and R⁴ may independently include any suitable number of carbon atoms. In some embodiments, each R³ and R⁴ may independently be an oligomer or polymer. In preferred embodiments, R¹ and R⁴ are independently a carbon-containing group with one to four carbon atoms. In some preferred embodiments, the R¹ and R⁴ groups on the acetal of Formula (IIA) are such that R³=R⁴. In some embodiments, R³ and R⁴ may be bonded to form a cyclic acetal.

The aldehyde may include a monoaldehyde. The aldehyde may include a dialdehyde or polyaldehyde. The aldehyde may be an oligomer.

The amide component and the aldehyde form a reaction product represented by formula (III):

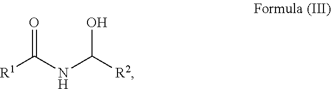

wherein R¹ is H or a carbon-containing group, optionally further substituted with one or more oxygen, nitrogen, or sulfur atoms or a combination thereof, preferably where R¹ is H or an alkyl, aryl, acyl, acrylate, carboxylic acid, urethane, ester, urea, carbonate, alkenyl, alkynyl, alkoxy, alcohol, amine, alkylamine, methacrylate, acrylamide, methacrylamide, vinyl, phenol, ketone, or amide group, and
R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, optionally wherein the aldehyde is in a protected form including an acetal or a hydrate.

The coating system may be free or substantially free of formaldehyde. The coating system may be free or substantially free of isocyanate.

The coating system may be curable at a temperature of 50° C. to 150° C., 75° C. to 150° C., 90° C. to 150° C., or 90° C. to 125° C.

According to an embodiment, a coating system includes a reaction product of: an amide component; and an aldehyde including two or more carbon atoms.

The reaction product may be a crosslinked product of Formula (IV), Formula (V), or Formula (VI):

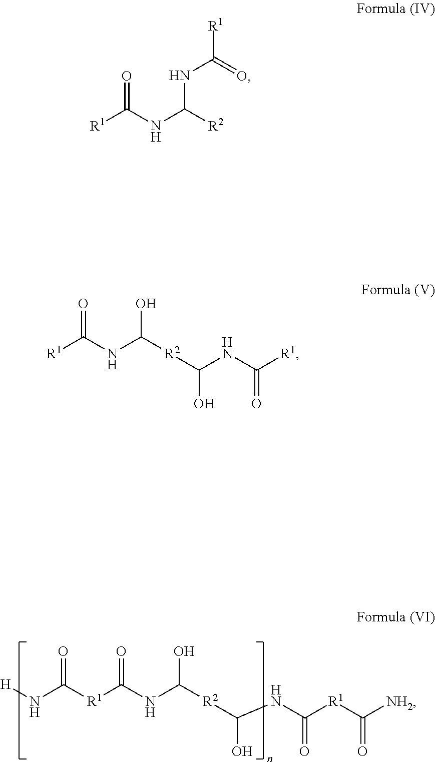

wherein R¹ is H or a carbon-containing group, optionally further substituted with one or more oxygen, nitrogen, or sulfur atoms or a combination thereof, preferably where R¹ is H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and
R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group.

The coating system may be in powder form. The coating system may include an organic solvent, water, or both.

The coating system may be free or substantially free of formaldehyde and structural units derived from formaldehyde. The coating system may be free or substantially free of isocyanate and structural units derived from isocyanate. The present disclosure further provides articles coated with the coating system.

### BRIEF DESCRIPTION OF FIGURES

FIG. 1 is an NMR spectrum of the sample produced in Example 3 according to an embodiment.

FIG. 2 is an NMR spectrum of the sample produced in Example 4 according to an embodiment.

FIG. 3 is an NMR spectrum of the sample produced in Example 6 according to an embodiment.

FIG. 4 is an NMR spectrum of an intermediate product produced in Example 7 according to an embodiment.

FIG. 5 is an NMR spectrum of the final sample produced in Example 9 according to an embodiment.

FIG. 6 is an NMR spectrum of the sample produced in Example 12 according to an embodiment.

### DEFINITIONS

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, the terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “aromatic ring” is used in this disclosure to refer to a conjugated ring system of an organic compound. Aromatic rings may include carbon atoms only, or may include one or more heteroatoms, such as oxygen, nitrogen, or sulfur.

The term “alkylated” is used in this disclosure to describe compounds that are reacted to replace a hydrogen atom or a negative charge of the compound with an alkyl group, such that the alkyl group is covalently bonded to the compound.

The term “alkyl” is used in this disclosure to describe a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Examples of alkyl groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, etc.

The term “crosslinker” refers to a molecule capable of forming a covalent linkage between separate polymers or between two different regions of the same polymer.

The term “group” is intended to be a recitation of both the particular moiety, as well as a recitation of the broader class of substituted and unsubstituted structures that includes the moiety. Thus, when the term “group” is used to describe a chemical substituent, the described chemical material includes the unsubstituted group (e.g., the moiety) and that group with O, N, Si, or S atoms, for example, in the chain (as in an alkoxy group) as well as carbonyl groups or other conventional substitution. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, isopropyl, t-butyl, heptyl, dodecyl, octadecyl, amyl, 2-ethylhexyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, isopropyl, t-butyl, heptyl, dodecyl, octadecyl, amyl, 2-ethylhexyl, and the like.

The term “substantially” as used here has the same meaning as “significantly,” and can be understood to modify the term that follows by at least about 90%, at least about 95%, or at least about 98%. The term “substantially free” of a particular compound means that the compositions of the present invention contain less than 1,000 parts per million (ppm) of the recited compound. The term “essentially free” of a particular compound means that the compositions of the present invention contain less than 100 parts per million (ppm) of the recited compound. The term “completely free” of a particular compound means that the compositions of the present invention contain less than 20 parts per billion (ppb) of the recited compound. In the context of the aforementioned phrases, the compositions of the present invention contain less than the aforementioned amount of the compound whether the compound itself is present in unreacted form or has been reacted with one or more other materials.

The term “not substantially” as used here has the same meaning as “not significantly,” and can be understood to have the inverse meaning of “substantially,” i.e., modifying the term that follows by not more than 25%, not more than 10%, not more than 5%, or not more than 2%.

The term “about” is used here in conjunction with numeric values to include normal variations in measurements as expected by persons skilled in the art, and is understood to have the same meaning as “approximately” and to cover a typical margin of error, such as ±5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5. etc. or 10 or less includes 10, 9.4, 7.6, 5, 4.3, 2.9, 1.62, 0.3, etc.). Where a range of values is “up to” or “at least” a particular value, that value is included within the range.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Any direction referred to here, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

### DETAILED DESCRIPTION

The present disclosure broadly relates to crosslinkable coating systems. The present disclosure further relates to methods of coating articles with the crosslinkable coating systems and to articles coated with the same.

A wide variety of coatings have been used to coat the surfaces of articles, structures, packaging, etc. For example, protective and/or decorative coatings may be applied to wood, wood products, metals, polymers, packaging materials, etc. With regard to coatings in general, there is a desire to use coating systems that are free of isocyanates and formaldehyde. Further, there is a need for finding alternative crosslinking chemical processes and methodologies to systems that include isocyanates or formaldehyde. In particular, there is a need for finding alternative crosslinking chemical processes and methodologies for two-part coating systems that typically include isocyanate, and for one-part coating systems that typically include formaldehyde.

The coating systems of the present disclosure may be used for many purposes and to coat various materials. The coating systems are suitable for use as coatings for wood, wood products, metals, polymers, packaging materials, etc. The coating systems may be used to coat, for example, structural features, architectural elements, articles, containers, packaging, etc. All such items are collectively referred to here as “articles.” The present disclosure provides methods of coating articles with the coating composition and articles coated with the coating composition.

According to an embodiment, the crosslinkable coating systems are based on two reactive compounds, an amide component and an aldehyde, and optionally a catalyst, and further optionally an amine. The amide and aldehyde may react to form a 2-hydroxy-alkylamide. This product may further react with another amide to form a bisamide. The reactions may be characterized as follows:

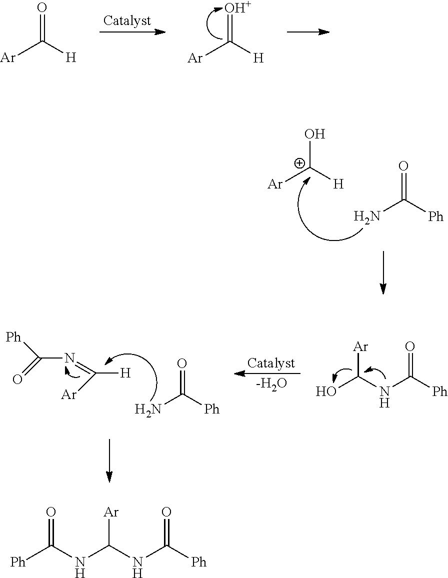

The amide may be a diamide or polyamide. When a diamide is reacted with a dialdehyde, the reaction product can be further reacted to form oligomers and polymers. The aldehyde may optionally be in a protected form, such as an acetal or a hydrate. In one embodiment, the crosslinkable coating system comprises a reaction product of amide and an aldehyde. In one embodiment, the crosslinkable coating system comprises a reaction product of a primary amide and an aldehyde. In one embodiment, the crosslinkable coating system comprises a reaction product of a diamide and an aldehyde. In one embodiment, the crosslinkable coating system comprises a reaction product of a diamide and a dialdehyde. In one embodiment, the crosslinkable coating system comprises an oligomeric or polymeric reaction product of a diamide and a dialdehyde. The crosslinkable coating system may also include reaction products of one or more different types of unsubstituted or substituted amides and one or more different types of aldehydes.

The combination of the amide and aldehyde provides a crosslinkable coating composition that is free or substantially free of formaldehyde, isocyanate, or both. According to an embodiment, the crosslinkable coating composition is free or substantially free of both formaldehyde and isocyanate. Many prior art one-part compositions include formaldehyde. The crosslinkable coating composition of the present disclosure may be a one-part composition that is free or substantially free of formaldehyde. Many prior art two-part compositions include isocyanate. The crosslinkable coating composition of the present disclosure may be a two-part composition that is free or substantially free of isocyanate.

The coating composition may be used to prepare a polymeric coating that is free or substantially free of formaldehyde and structural units derived from formaldehyde. The coating composition may be used to prepare a polymeric coating that is free or substantially free of isocyanate and structural units derived from isocyanate. The coating composition may be used to prepare a polymeric coating that is free or substantially free of formaldehyde and structural units derived from formaldehyde and free or substantially free of isocyanate and structural units derived from isocyanate.

In some embodiments, the coating composition of the present disclosure may be a one-component system, or it may be a two-component system. In other words, the coating composition may be a one-part system or a two-part system. The coating composition being a one-part system refers to the ingredients of the coating system being in a pre-mixed form, i.e., the reagents are provided as a pre-mixed mixture. Such pre-mixed mixtures do not have to be mixed immediately prior to application of the coating on the article or surface being coated with the coating system. In embodiments where the coating composition is a one-part system, the reactivity of the reagents (unsubstituted or substituted amide, aldehyde, and optional catalyst) may be selected to keep the reaction from occurring too soon (e.g., prior to application of the coating composition). For example, the amide and/or the aldehyde may be selected to have a higher or lower reactivity. Further, at least some of the functional groups of the reagents may be shielded using protective groups (for example, by forming acetal groups or hydrates on the aldehyde) that prevent the reaction from occurring until the protective group is removed.

The coating composition being a two-part coating system refers to the composition of the coating system not being in a pre-mixed form. It refers to the coating system being comprised of two mixtures of the reagents of the coating system. The reagents in the two mixtures are substantially unreactive until the two mixtures (or “two parts”) are combined together. Combining the two “parts” of a two-part coating system allows the reagents to react and form the coating.

### Amide

According to an embodiment, the crosslinkable coating systems includes a reaction product of an amide and an aldehyde. The amide may preferably be a primary amide.

According to an embodiment, the amide is represented by Formula (I):

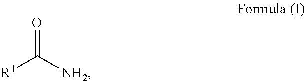

where R¹ is H or a carbon-containing group, optionally further substituted with one or more oxygen, nitrogen, or sulfur atoms or a combination thereof, preferably where R¹ is H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. R¹ may be straight, branched, or cyclic, and may include zero, one, or more double bonds. R¹ may include any suitable number of carbon atoms. In some embodiments, R¹ may be an oligomer or polymer.

According to an embodiment, the amide is formamide, represented by Formula (IA):

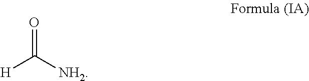

According to an embodiment, the amide is a substituted primary amide where the carbonyl carbon is substituted. According to an embodiment, the carbonyl carbon is substituted with an alkyl. One example of such amide is acetamide, represented by Formula (IB-1):

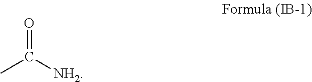

According to an embodiment, the carbonyl carbon is substituted with a vinyl group. One example of such amide is methacrylamide, represented by Formula (IB-2):

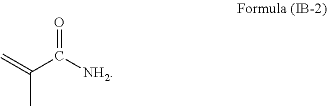

According to an embodiment, the carbonyl carbon is substituted with a phenyl group. One example of such amide is benzamide, represented by Formula (IB-3):

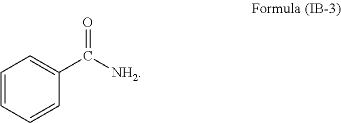

According to an embodiment, the amide is a diamide represented by Formula (IC):

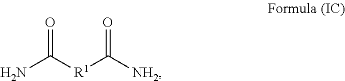

where R¹ is a carbon-containing group optionally further substituted with one or more oxygen, nitrogen, or sulfur atoms or a combination thereof, preferably where R¹ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. R¹ may be straight, branched, or cyclic, and may include zero, one, or more double bonds. R¹ may include any suitable number of carbon atoms. In some embodiments, R¹ may be an oligomer or polymer.

According to an embodiment, the diamide is malonamide (malonic acid diamide) represented by Formula (IC-1):

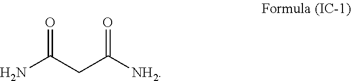

According to an embodiment, the diamide is phthalamide represented by Formula (IC-2):

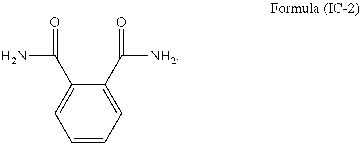 [SMILES: NC(=O)c1ccccc1C(N)=O]

In some embodiments, Formula (I) is not or does not include polyether.

The amide may be a triamide or polyamide, analogous to the diamide of Formula (IC).

The amide may further include branched amide functionalities, such as in the following structure:

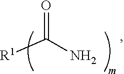

where m is 2, 3, or 4.

### Aldehyde

The aldehyde may be a monoaldehyde, dialdehyde, trialdehyde, or polyaldehyde. The aldehyde may be an oligomer or a polymer. The aldehyde may optionally be in a protected form prior to reaction, such as an acetal or a hydrate. In some embodiments, the aldehyde is liquid at room temperature (about 20° C. to 25° C.). The aldehyde may also have low toxicity and acceptable smell.

In some embodiments, the aldehyde is a monoaldehyde. Examples of suitable aldehydes include heptanal, octanal, cyclohexane carboxaldehyde, benzaldehyde, furfural, vanillin, hydroxymethyl furfural (“HMF”), pivaldehyde, hydroxypivaldehyde, aliphatic aldehydes obtained by oxidative cleavage of double bonds, and the like. In some cases, the aldehyde may be biobased, that is obtained from non-petroleum-based sources.

The aldehyde may be represented by Formula (II):

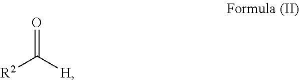

where R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. R² may be straight, branched, or cyclic, and may include zero, one, or more double bonds. R² may include any suitable number of carbon atoms. In some embodiments, R² may be an oligomer or polymer.

In some embodiments, the aldehyde in the crosslinkable coating systems of the present disclosure is a polyaldehyde. In some embodiments, the polyaldehyde in the crosslinkable coating systems of the present disclosure is chosen from a group consisting of terephthaldehyde, glutaraldehyde, glyoxal, dimethoxy acetaldehyde, methylglyoxal, cyclohexanedicarbaldehyde, malondialdehyde bis(dimethyl acetal), 5,5′-(oxy-bis(methylene))bis-2-furfural, bis(dimethyl acetal) of imidazolidone, tetra-dimethyl acetal of glycoluryl, bis(dimethyl acetal) of polyglycidyl ether, tri(aminoethyl dimethyl acetal) of itaconic, tri(aminoethyl dimethyl acetal) of TMPEOTA, poly(dimethyl acetal) of polycyclocarbonate.

In some embodiments, the aldehyde is a dialdehyde, represented by Formula (IIA):

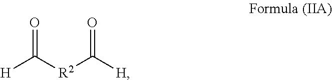

where R² is a carbon-containing group, optionally further substituted with one or more oxygen, nitrogen, or sulfur atoms or a combination thereof, preferably where R⁶ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. R² may be straight, branched, or cyclic, and may include zero, one, or more double bonds. R² may include any suitable number of carbon atoms. In some embodiments, R² may be an oligomer or polymer.

In some embodiments, the dialdehyde may be a cycloaliphatic dialdehyde, such as cyclohexanedicarboxaldehyde, represented by Formula (IIA-1):

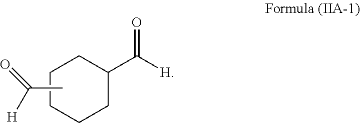

In some embodiments, the aldehyde may be represented by Formula (IIB):

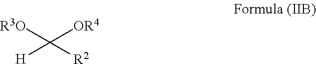

where R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. In some embodiments, R² may be straight, branched, or cyclic, and may include zero, one, or more double bonds. R² may include any suitable number of carbon atoms. In some embodiments, R² may be an oligomer or polymer. And where each R¹ and R⁴ are independently a carbon-containing group, optionally further substituted with one or more oxygen, nitrogen, or sulfur atoms or a combination thereof, preferably where each R³ and R⁴ are independently an alkyl, aryl, acyl, acrylate, carboxylic acid, urethane, ester, amide, carbonate, alkenyl, alkynyl, alkoxy, alcohol, amine, methacrylate, acrylamide, methacrylamide, vinyl, phenol, ketone, alkylamine, or urea group. Each R³ and R⁴ may independently be straight, branched, or cyclic, and may include zero, one, or more double bonds. Each R¹ and R⁴ may independently include any suitable number of carbon atoms. In some embodiments, each R³ and R⁴ may independently be an oligomer or polymer. In preferred embodiments, R³ and R⁴ are independently a carbon-containing group with one to four carbon atoms. In some preferred embodiments, the R¹ and R⁴ groups on the acetal of Formula (IIA) are such that R¹=R⁴. In some embodiments, R³ and R⁴ may be bonded to form a cyclic acetal.

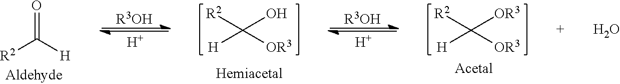

In some embodiments, the aldehyde is in a protected form as a hydrate. The hydrate is obtained by the reaction of water on the aldehyde and may be represented by the formula:

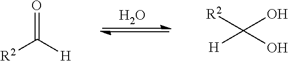

where R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. In some embodiments, R² may be straight, branched, or cyclic, and may include zero, one, or more double bonds. R² may include any suitable number of carbon atoms. In some embodiments, R² may be an oligomer or polymer. In the following, the term aldehyde described an aldehyde or a hydrate or an acetal.

In some embodiments, the aldehyde is a polyaldehyde, such as terephthaldehyde, glutaraldehyde, glyoxal, dimethoxy acetaldehyde, methylglyoxal, cyclohexanedicarbaldehyde, and malondialdehyde bis(dimethyl acetal), 5,5-′(oxy-bis(methylene))bis-2-furfural, bis(dimethyl acetal) of imidazolidone, tetra-dimethyl acetal of glycoluryl, bis(dimethyl acetal) of polyglycidyl ether, tri(aminoethyl dimethyl acetal) of itaconic, tri(aminoethyl dimethyl acetal) of TMPEOTA, poly(dimethyl acetal) of polycyclocarbonate.

In some embodiments, the aldehyde is an oligomer or a polymer. The oligomer or polymer aldehyde may include a plurality of aldehyde functional groups. For example, the aldehyde may be a dialdehyde obtained by condensation of a hydroxyaldehyde, such as 5,5′-[oxy-bis(methylene)]di(2-furaldehyde). The dialdehyde may be formed by crotonization with an enolizable ketone, such as cyclohexanone. In one example, a dialdehyde is formed from HMF and cyclohexanone. The ketone may be used at a ratio of HMF/cyclohexanone that is greater than 1. The aldehyde may be a dialdehyde obtained by coupling two hydroxyaldehydes by the use of a dicarbamate.

In some embodiments, the aldehyde is an acrylic (co)polymer, which may be obtained by free radical polymerization of a monomer mixture containing aldehyde-functional monomers. Such aldehyde-functional monomers may be obtained in various ways. For example, such aldehyde-functional monomers may be based on acrolein, acrolein diethyl acetal, N-methacrylamidoacetaldehyde dimethyl acetal or 5-(hydroxymethyl)furfural methacrylate (HMF) methacrylate, or 4-methacryloyloxy-3-methoxybenzaldehyde (vanillin methacrylate). Or the reaction product between aminoacetaldehyde dimethyl acetal (or (methylamino)acetaldehyde dimethyl acetal) and glycidyl ether methacrylate (GMA) or glycerol carbonate methacrylate (GCMA) or 4-(chloromethyl)styrene (CMS) or 3-acryloyloxy-2-hydroxypropyl methacrylate:
with R=H or CH₃

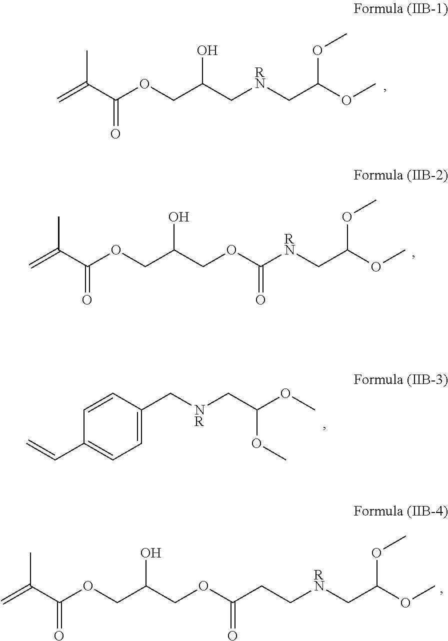

or the reaction product of pivaldehyde with methacrylic anhydride or 4-(chloromethyl)styrene

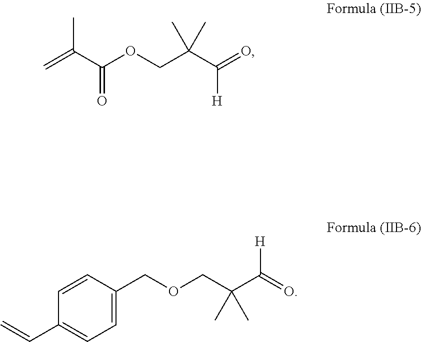 [SMILES: C=C(C)C(=O)OCC(C)(C)C=O ; C=Cc1ccc(COCC(C)(C)C=O)cc1]

In some embodiments, the aldehyde may be a polyester resin, which may be obtained by esterification or transesterification of a monomer mixture containing aldehyde-functional monomers. Such aldehyde-functional monomers may be obtained in various ways. For example, such aldehyde-functional monomers may be based on itaconate reacted by aza-Michael addition with aminoacetaldehyde dimethyl acetal or (methylamino)acetaldehyde dimethyl acetal.

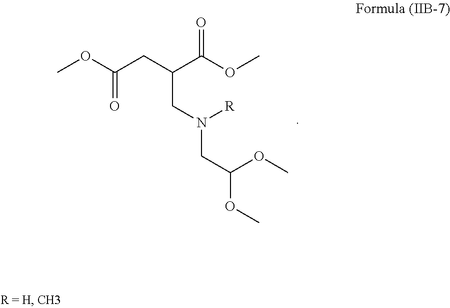

### Coating Systems

According to an embodiment, the coating system of the present disclosure includes an amide according to Formula (I) (e.g., Formula (IA)-(IC)) as described above, and an aldehyde according to Formula (II) (e.g., Formula (IIA)-(IIB)) as described above. In some embodiments, the coating system of present disclosure may also include a solvent. In some embodiments, the amide and aldehyde may be present at a molar ratio of 0.5 to 2.5 moles, 0.5 to 2.0 moles, 1.0 to 2.0 moles, or 1.5 to 2.5 moles of amide for every 1 mole of the aldehyde. According to an embodiment, the coating system is crosslinkable.

According to an embodiment, the crosslinkable coating system is provided as a one-part composition or a two-part composition. The crosslinkable coating system may be a dry powder composition or a solvent-based composition. A dry powder composition is a composition where each component is in powder form. The dry powder components are blended together and may be applied in powder form. The components of a solvent-based system may be either liquid or powder, mixed into a solvent and applied in liquid form.

In embodiments where the composition is solvent-based, the coating composition includes 1 wt-% or more, 2 wt-% or more, 5 wt-% or more, 10 wt-% or more, 20 wt-% or more, 30 wt-% or more, or 40 wt-% or more of the combined amide and aldehyde, based on total resin solids included in the coating composition. The coating composition may include 60 wt-% or less, 50 wt-% or less, 40 wt-% or less, 30 wt-% or less, 20 wt-% or less, or 10 wt-% or less of the combined amide and aldehyde, based on total resin solids included in the coating composition.

The solvent-based composition may include water or organic solvents or a combination thereof. Exemplary solvents include ketones, acetates, aromatics, alcohols, ethers, and combinations thereof, including aqueous mixtures.

The coating composition may also optionally be rheologically modified for different coating applications. For example, the coating composition may be diluted with additional amounts of the solvent to reduce the total solids content in the coating composition. Alternatively, portions of the solvent may be removed (e.g., evaporated) to increase the total solids content in the coating composition. The final total solids content in the coating composition may vary depending on the particular coating application used, the particular coating use, the desired coating thickness, and the like.

In some embodiments, the coating composition has a total solids weight greater than about 5%, more preferably greater than about 10%, and even more preferably greater than about 15%, based on the total weight of the coating composition. In liquid embodiments, the coating composition also preferably has a total solids weight less than about 80%, more preferably less than about 60%, and even more preferably less than about 50%, based on the total weight of the coating composition. The solvent (e.g., aqueous or organic solvent) may constitute the remainder of the weight of the coating composition.

In one embodiment, the coating composition is a powder coating composition. The powder coating composition may include a base powder formed at least in part from the polymer of the present disclosure. The coating composition may include one or more optional ingredients in the particles of the base powder and/or in separate particles. Such optional ingredients may include, for example, crosslinkers, cure accelerators, colored pigments, fillers, flow additives, or the like.

The coating composition may optionally include one or more additional resins in addition to the reaction products of the amide and aldehyde. For example, additional resins may be included to alter the properties of the resulting coating.

The coating composition may optionally include one or more additives. When used, the additives preferably enhance and preferably do not adversely affect the coating composition, or a cured coating formed from the coating composition. For example, additives may be included in the coating composition to enhance composition aesthetics, to facilitate manufacturing, processing, handling, and application of the composition, and to further improve a particular functional property of the coating composition or a cured coating resulting therefrom. Such optional additives include, for example, catalysts, dyes, pigments, toners, extenders, fillers, lubricants, anticorrosion agents, flow control agents, thixotropic agents, dispersing agents, antioxidants, adhesion promoters, light stabilizers, co-resins and mixtures thereof. Each optional additive is preferably included in a sufficient amount to serve its intended purpose, but not in such an amount to adversely affect the coating composition or a cured coating resulting therefrom.

In some embodiments, the coating composition includes one or more catalysts. In some embodiments, the coating composition includes an acid catalyst. Suitable acid catalysts are acids with a pKa of less than 7 or less than 6. An acid functionality on the polymer may also act as a catalyst.

Examples of acid catalysts include Lewis acids (e.g., boron trifluoride etherate) and protic acids (i.e., Bronsted acids). In some embodiments, the acid catalyst is an inorganic protic acid such as phosphoric acid or sulfuric acid, or an organic protic acid such as carboxylic acid, phosphonic acid, or sulfonic acid. Exemplary carboxylic acids suitable for use as acid catalysts include acetic acid, trifluoroacetic acid, and propionic acid. An exemplary phosphonic acid is methylphosphonic acid. Exemplary sulfonic acids include methanesulfonic acid, benzenesulfonic acid, camphorsulfonic acid; para-toluenesulfonic acid (PTSA), and dodecylbenzenesulfonic acid (DBSA). Examples of suitable Lewis acid catalysts are aluminum trichloride (AlCl₃), benzyltriethylammonium chloride (TEBAC), Cu(O₃SCF₃)₂, (CH₃)₂BrSBr, FeCl₃ (e.g., FeCl₃·6 H₂O), HBF₄, BF₃·O(CH₂CH₃)₂, TiCl₄, SnCl₃, CrCl₂, NiCl₂, ZnBr₂, and Pd(OC(O)CHs)₂. The acid catalyst may be unsupported (include no solid support) or supported, for example covalently bonded to a solid support.

Another useful optional additive is a lubricant (e.g., a wax), which facilitates manufacture of metal closures and other fabricated coated articles by imparting lubricity to coated metal substrates. Preferred lubricants include, for example, carnauba wax and polyethylene-type lubricants. If used, a lubricant is preferably present in the coating composition in an amount of at least about 0.1% by weight, and preferably no greater than about 2% by weight, and more preferably no greater than about 1% by weight, based on the total solids weight of the coating composition.

Another useful optional additive is an organosilicon material, such as siloxane-based or polysilicon-based materials. Representative examples of suitable such materials are disclosed in International Application Nos. WO 2014/089410 A1 and WO 2014/186285 A1.

Another useful optional ingredient is a pigment, such as titanium dioxide. If used, a pigment is present in the coating composition in an amount of no greater than about 70% by weight, more preferably no greater than about 50% by weight, and even more preferably no greater than about 40% by weight, based on the total solids weight of the coating composition.

The amide and aldehyde may react to form a bisamide.

Exemplary reactions include the reaction of methacrylamide and octanal:

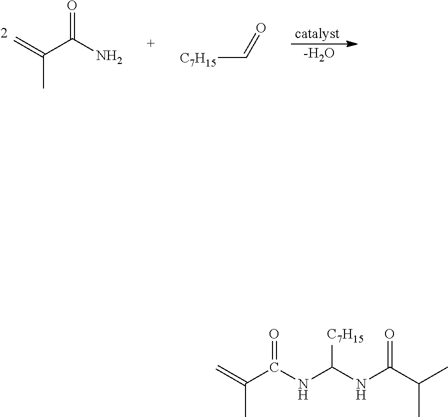

The reaction of acetamide and octanal:

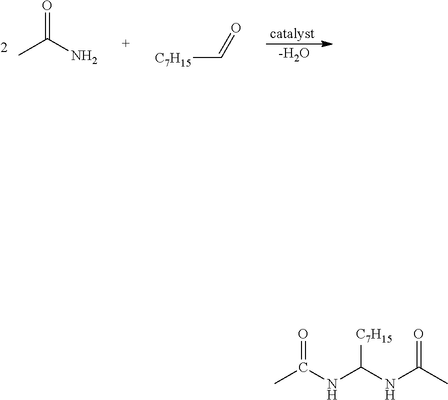

The reaction of benzamide and cyclohexanecarboxaldehyde.

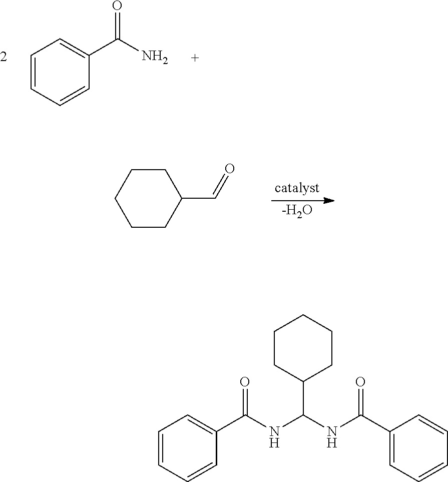 [SMILES: NC(=O)c1ccccc1 ; O=CC1CCCCC1 ; "-H2O" ; O=C(NC(NC(=O)c1ccccc1)C1CCCCC1)c1ccccc1]

The reaction product of an amide and the aldehyde may be represented by Formula (III).

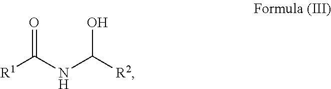

where R¹ is as in Formula (I), and R² is as in Formula (II).

If excess amide is present, the reaction may proceed further to produce Formula (IV):

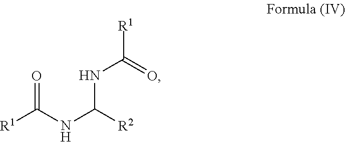

where R¹ is as in Formula (I), and R² is as in Formula (II).

When an amide is reacted with a dialdehyde, the reaction product may be represented by Formula (V):

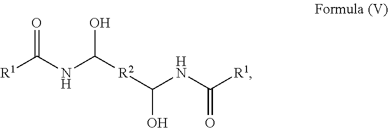

where R¹ is as in Formula (I), and R² is as in Formula (IIA).

When a diamide is reacted with a dialdehyde, the reaction may produce an oligomer or polymer represented by Formula (VI):

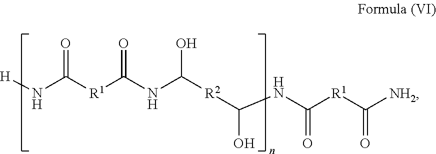

where R¹ is as in Formula (IC), and R² is as in Formula (IIA).

The reaction product (which forms the coating composition) may be applied onto a surface and cured to cause crosslinking. The resulting coating may be a poly(hydroxy-alkylamide) functionalized network (if using Formula III or an analogous reaction product) or a poly(bisamide) functionalized network (if using Formula IV or an analogous reaction product). According to an embodiment, the coating composition is free or substantially free of isocyanates. According to an embodiment, the coating composition is free or substantially free of formaldehyde. According to an embodiment, the coating composition is free or substantially free of both isocyanates and formaldehyde.

### Curing/Crosslinking

After having been applied onto a surface, the coating composition may be cured to cause crosslinking of the composition.

The coating composition may be cured at a temperature of 150° C. or lower, 125° C. or lower, 110° C. or lower, 100° C. or lower, 90° C. or lower, 80° C. or lower, or 70° C. or lower. The coating composition may be cured at a temperature of 50° C. or higher, 75° C. or higher, 80° C. or higher, 90° C. or higher, or 100° C. or higher. The coating composition may be cured at temperatures ranging from 50° C. to 150° C., 75° C. to 150° C., 90° C. to 150° C., or 90° C. to 125° C. In some embodiments, the coating composition is curable at room temperature.

In some embodiments, it may be desirable for the coating composition not to react at low temperatures, such as at room temperature. The components of the coating composition may be selected to achieve desired curing and cross-linking conditions.

The additives used in the coating composition may also be selected to achieve desired reaction conditions. For example, acid catalyst or a polymer chain bearing carboxylic acid functionalities may be used to improve reactivity of the crosslinking reaction.

### Methods of Coating and Coated Articles

The present disclosure provides methods of coating articles with the coating composition and articles coated with the coating composition. The coating compositions of the present disclosure may be used for many purposes and to coat various materials. The coating compositions are suitable for use as coatings for wood, wood products, metals, polymers, packaging materials, etc.

According to an embodiment, a method of coating an embodiment includes applying a coating composition to a surface of the article and curing the coating composition. The coating composition includes an amide according to Formula (I) (e.g., Formula (IA)-(IC)) as described above, and an aldehyde according to Formula (II) (e.g., Formula (IIA)HIIB)) as described above.

In some embodiments, a packaging article has a coating according to an embodiment of the present disclosure disposed on a surface of the packaging article. In one embodiment, the packaging article is a container such as a food or beverage container, or a portion thereof (e g., a twist-off closure lid, beverage can end, food can end, etc.), where at least a portion of an interior surface of the container is coated with the coating composition. The coating may include a reaction product of an amide according to Formula (I) (e.g., Formula (IA)-(IC)) as described above, and an aldehyde according to Formula (II) (e.g., Formula (IIA)-(IiB)) as described above. The coating may include a network formed from the reaction product of Formula (III) as described above. The coating may include a network formed from the reaction product of Formula (IV) as described above. The coating may include a network formed from the reaction product of Formula (V) as described above. The coating may include a network formed from the reaction product of Formula (VI) as described above. The coating may be a crosslinked coating resulting from crosslinking of the reaction product of Formula (III), Formula (IV), Formula (V), or Formula (VI).

### Exemplary Embodiments

Embodiment 1 is a coating system comprising:
an amide,
an aldehyde comprising two or more carbon atoms; and
a solvent.
   Embodiment 2 is the coating system of embodiment 1, wherein the amide is present at a molar ratio of 0.5 to 2.5 moles, 0.5 to 2.0 moles, 1.0 to 2.0 moles, or 1.5 to 2.5 moles of amide for every 1 mole of the aldehyde.
   Embodiment 3 is the coating system of embodiment 1 or 2, wherein the amide is represented by Formula (I):

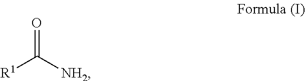

wherein R¹ is independently H or a carbon-containing group, optionally further substituted with one or more oxygen, nitrogen, or sulfur atoms or a combination thereof, preferably wherein R¹ is H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group.
   Embodiment 4 is the coating system of any one of embodiments 1 to 3, wherein the amide comprises acetamide, methacrylamide, benzamide, or a combination thereof. Embodiment 5 is the coating system of any one of embodiments 1 to 4, wherein the amide comprises a diamide, triamide, or polyamide.
   Embodiment 6 is the coating system of any one of embodiments 1 to 5, wherein the amide comprises malonamide, phthalamide, or a combination thereof.
   Embodiment 7 is the coating system of any one of embodiments 1 to 6, wherein the amide comprises branched amide functionalities, such as in the following structure:

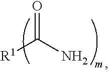

where m is 2, 3, or 4.

Embodiment 8 is the coating system of any one of embodiments 1 to 7, wherein the aldehyde may be represented by Formula (11) or (IIB):

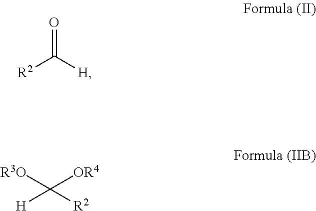

wherein R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, optionally wherein the aldehyde is in a protected form including an acetal or a hydrate. And where each R¹ and R⁴ are independently a carbon-containing group, optionally further substituted with one or more oxygen, nitrogen, or sulfur atoms or a combination thereof, preferably where each R³ and R⁴ are independently an alkyl, aryl, acyl, acrylate, carboxylic acid, urethane, ester, amide, carbonate, alkenyl, alkynyl, alkoxy, alcohol, amine, methacrylate, acrylamide, methacrylamide, vinyl, phenol, ketone, alkylamine, or urea group. Each R³ and R⁴ may independently be straight, branched, or cyclic, and may include zero, one, or more double bonds. Each R³ and R⁴ may independently include any suitable number of carbon atoms. In some embodiments, each R³ and R may independently be an oligomer or polymer. In preferred embodiments, R³ and R⁴ are independently a carbon-containing group with one to four carbon atoms. In some preferred embodiments, the R¹ and R⁴ groups on the acetal of Formula (IIA) are such that R¹=R⁴. In some embodiments, R³ and R⁴ may be bonded to form a cyclic acetal.
   The aldehyde may include a monoaldehyde. The aldehyde may include a dialdehyde or polyaldehyde. The aldehyde may be an oligomer.
   Embodiment 9 is the coating system of embodiment 8, wherein the aldehyde comprises a monoaldehyde.
   Embodiment 10 is the coating system of embodiment 8, wherein the aldehyde comprises a dialdehyde or polyaldehyde.
   Embodiment 11 is the coating system of embodiment 8, wherein the aldehyde comprises cyclohexanedicarboxaldehyde.
   Embodiment 12 is the coating system of embodiment 8, wherein the aldehyde is an oligomer.
   Embodiment 13 is the coating system of any one of embodiments 1 to 12, wherein the amide and the aldehyde form a reaction product represented by formula (III):

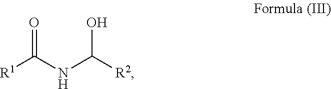

wherein R¹ is H or a carbon-containing group, optionally further substituted with one or more oxygen, nitrogen, or sulfur atoms or a combination thereof, preferably where R¹ is H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and
R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group.
   Embodiment 14 is the coating system of any one of embodiments 1 to 13, wherein the amide and the aldehyde form a reaction product represented by formula (IV).

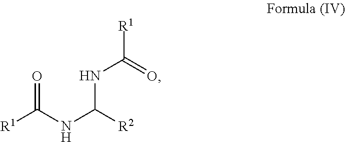

wherein each R¹ is independently H or a carbon-containing group, optionally further substituted with one or more oxygen, nitrogen, or sulfur atoms or a combination thereof, preferably where R¹ is H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and
R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group.
   Embodiment 15 is the coating system of any one of embodiments 1 to 14, wherein the amide and the aldehyde form a reaction product represented by Formula (V):

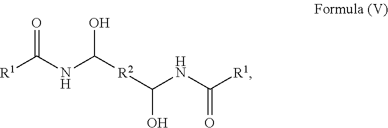

wherein each R¹ is independently H or a carbon-containing group, optionally further substituted with one or more oxygen, nitrogen, or sulfur atoms or a combination thereof, preferably where R¹ is H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and
R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group.
   Embodiment 16 is the coating system of any one of embodiments 1 to 15, wherein the amide and the aldehyde form a reaction product represented by Formula (VI):

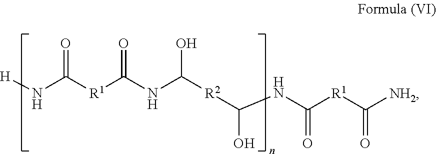

wherein each R¹ is independently H or a carbon-containing group, optionally further substituted with one or more oxygen, nitrogen, or sulfur atoms or a combination thereof, preferably where R¹ is H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and
R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group.
   Embodiment 17 is the coating system of any one of embodiments 1 to 16, wherein the coating system is free or substantially free of formaldehyde.
   Embodiment 18 is the coating system of any one of embodiments 1 to 17, wherein the coating system is free or substantially free of isocyanate.
   Embodiment 19 is the coating system of any one of embodiments 1 to 18, wherein the coating system is curable at a temperature of 50° C. to 150° C., 75° C. to 150° C., 90° C. to 150° C., or 90° C. to 125° C.
   Embodiment 20 is the coating system of any one of embodiments 1 to 19, wherein the coating system comprises 1 wt-% or more, 2 wt-% or more, 5 wt-% or more, 10 wt-% or more, 20 wt-% or more, 30 wt-% or more, or 40 wt-% or more of the combined amide and aldehyde, based on total resin solids included in the coating system. The coating system may include 60 wt-% or less, 50 wt-% or less, 40 wt-% or less, 30 wt-% or less, 20 wt-% or less, or 10 wt-% or less of the combined amide and aldehyde, based on total resin solids included in the coating composition.
   Embodiment 21 is the coating system of any one of embodiments 1 to 20, wherein the solvent comprises water or an organic solvent or a combination thereof, optionally wherein the solvent comprises a ketone, acetate, aromatics, alcohol, ether, or a combination thereof, including aqueous mixtures.
   Embodiment 22 is the coating system of any one of embodiments 1 to 21, wherein the coating system comprises an acid catalyst, optionally wherein the acid catalyst has a pKa of less than 7 or less than 6.
   Embodiment 23 is the coating system of embodiment 22, wherein the acid catalyst comprises phosphoric acid, sulfuric acid, acetic acid, trifluoroacetic acid, propionic acid, methylphosphonic acid, methanesulfonic acid, benzenesulfonic acid, camphorsulfonic acid, para-toluenesulfonic acid (PTSA), dodecylbenzenesulfonic acid (DBSA), aluminum trichloride (AlC3), benzyltriethylammonium chloride (TEBAC), Cu(O₃SCF₃)₂, (CH₃)₂BrSBr, FeCl₃, HBF₄, BF₃·O(CH₂CH₃)₂, TiCl₄, SnCl₄, CrCl₂, NiCl₂, ZnBr₂ Pd(OC(O)CH₃)₂, or a combination thereof.
   Embodiment 24 is a coating system comprising a reaction product of:
an amide; and
an aldehyde comprising two or more carbon atoms.
   Embodiment 25 is the coating system of embodiment 24, wherein the reaction product comprises bisamide.
   Embodiment 26 is the coating system of embodiment 24 or 25, wherein the reaction product is a crosslinked product of Formula (IV), Formula (V), or Formula (VI):

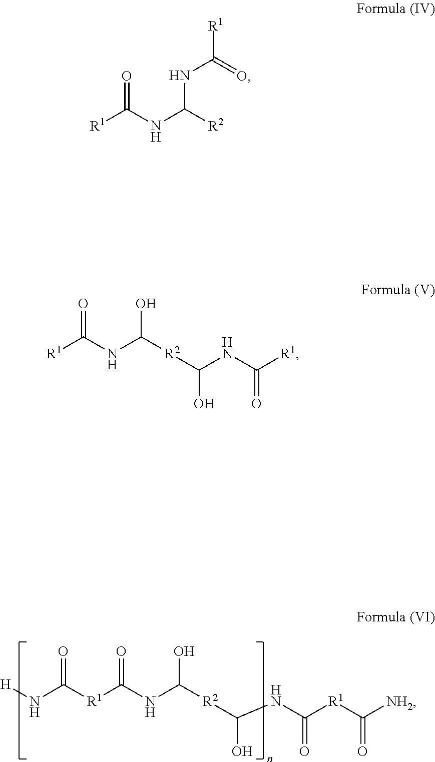

wherein R¹ is independently H or a carbon-containing group, optionally further substituted with one or more oxygen, nitrogen, or sulfur atoms or a combination thereof, preferably where R¹ is H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and
R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group.
   Embodiment 27 is the coating system of any one of embodiments 24 to 26, wherein the reaction product comprises the reaction of methacrylamide and octanal:

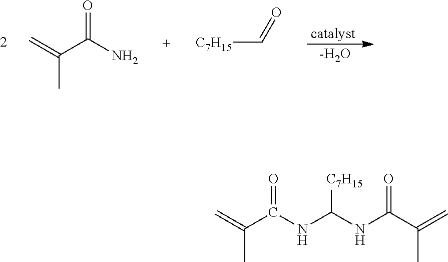

Embodiment 28 is the coating system of any one of embodiments 24 to 26, wherein the reaction product comprises reaction of acetamide and octanal:

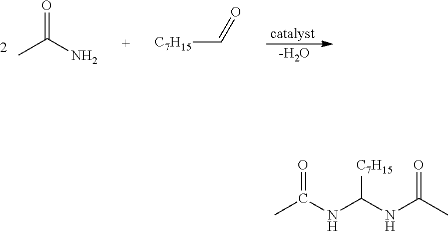

Embodiment 29 is the coating system of any one of embodiments 24 to 26, wherein the reaction product comprises reaction of benzamide and cyclohexanecarboxaldehyde:

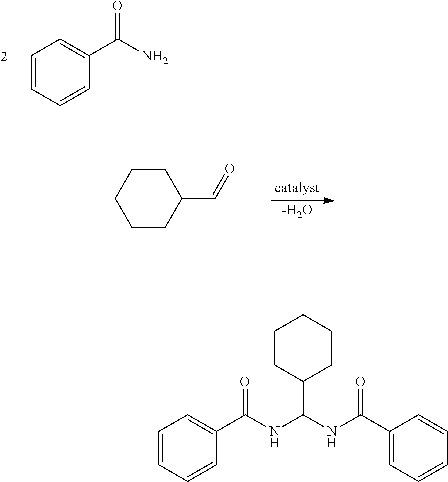 [SMILES: NC(=O)c1ccccc1 ; O=CC1CCCCC1 ; "-H2O" ; O=C(NC(NC(=O)c1ccccc1)C1CCCCC1)c1ccccc1]

Embodiment 30 is the coating system of any one of embodiments 24 to 29, wherein the coating system is in powder form.
Embodiment 31 is the coating system of any one of embodiments 24 to 30, wherein the coating system comprises an organic solvent, water, or both, optionally wherein the solvent comprises a ketone, acetate, aromatics, alcohol, ether, or a combination thereof, including aqueous mixtures.
Embodiment 32 is the coating system of any one of embodiments 24 to 31, wherein the coating system is free or substantially free of formaldehyde and structural units derived from formaldehyde.
Embodiment 33 is the coating system of any one of embodiments 24 to 32, wherein the coating system is free or substantially free of isocyanate and structural units derived from isocyanate.
Embodiment 34 is the coating system of any one of embodiments 24 to 33, wherein the coating system comprises one or more of crosslinkers, cure accelerators, fillers, catalysts, dyes, pigments, toners, extenders, lubricants, anticorrosion agents, flow control agents, thixotropic agents, dispersing agents, antioxidants, adhesion promoters, light stabilizers, co-resins, and combinations thereof.
Embodiment 35 is an article coated with the coating system of any one of the preceding embodiments.

### EXAMPLES

### Example 1

Reaction of Benzamide with Cyclohexanedicarboxaldehyde.

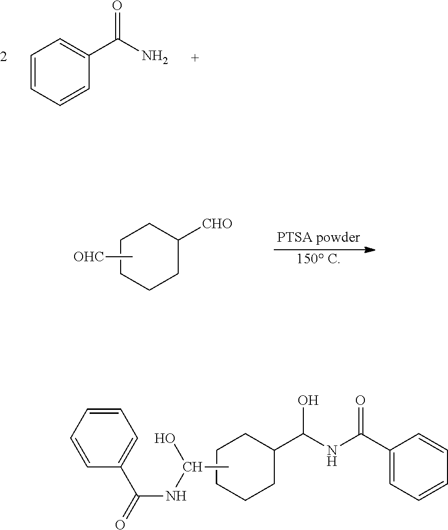

42.40 g (0.35 amide equivalents) of benzamide and 26.25 g (0.35 aldehyde equivalents) of cyclohexanedicarboxaldehyde (PARALOID™ EDGE XL-195, available from Dow Chemical Company in Midland, MI) were loaded into a reaction vessel equipped with a thermometer, a mechanical stirrer (100 rpm) and a nitrogen inlet. The reaction mixture was stirred while being heated tol 50° C. Once the reaction temperature reached 100° C., 0.69 g of p-toluenesulfonic acid (PTSA) powder was added to the mixture as a catalyst when the mixture was at 100° C. Ten minutes after addition of the catalyst, the resin became compact solidified at 150° C., and a change in color was observed. It was concluded that benzamide and cyclohexanedicarboxaldehyde reacted with each other.

### Example 2

Reaction of Malonamide with Cyclohexanedicarboxaldehyde

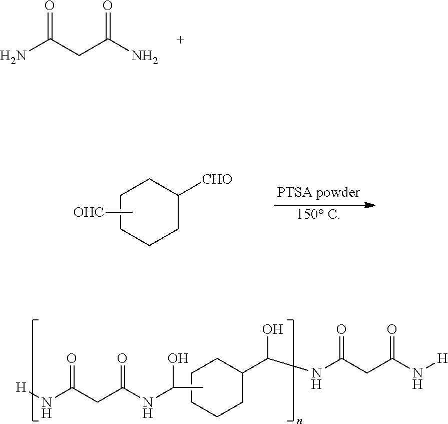

25.53 g (0.5 amide equivalents) of malonamide and 37.50 g (0.5 aldehyde equivalents) of cyclohexanedicarboxaldehyde (PARALOID™ EDGE XL-195) loaded into a reaction vessel equipped with a thermometer, a mechanical stirrer (100 rpm) and a nitrogen inlet. The reaction mixture was stirred while being heated to 150° C. Once the reaction temperature reached 100° C., 0.63 g of p-toluenesulfonic acid (PTSA) powder was added to the mixture as a catalyst when the mixture was at 85° C. Five minutes after addition of the catalyst, the resin became compact solidified at 150° C., and a change in color was observed. It was concluded that benzamide and cyclohexanedicarboxaldehyde reacted with each other and underwent polymerization.

### Example 3

Synthesis of Dimethyl Acetal Methacrylamide from MAAH and Aminoacetaldehyde Dimethyl Acetal

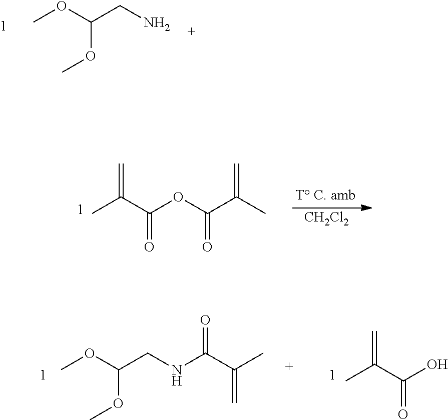

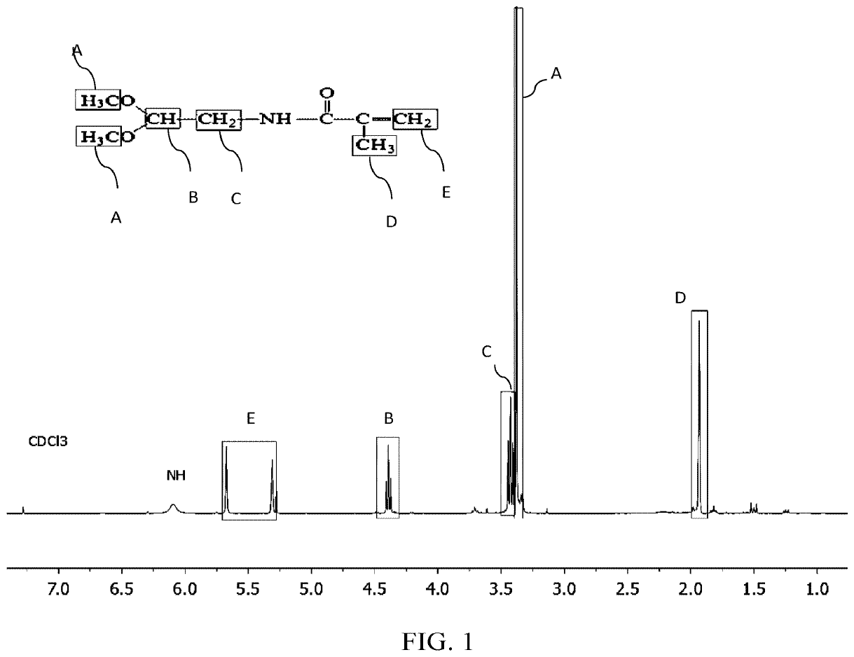

70 g (0.67 moles) of aminoacetaldehyde dimethyl acetal and 300 g of dichloromethane were loaded into a 500 ml reaction vessel under constant stirring, 102.64 g (0.67 moles) of methacrylic anhydride (MAAH) was added to the reaction vessel and the reaction mixture stirred at 50° C. for 10 hours. Next, the reaction mixture was allowed to cool and placed in a settling ampoule. 100 ml of a basic aqueous solution was added to it for the removal of acrylic acid, followed by rinsing with a neutral aqueous solution. Removal of solvent furnished the product as a pure viscous liquid in 95% yield. The product was analyzed by ¹H-NMR. The ¹H-NMR spectrum of the product is shown in FIG. 1.

### Example 4

Synthesis of Polyacetal from Polyacrylate and Aminoacetaldehyde Dimethyl Acetal

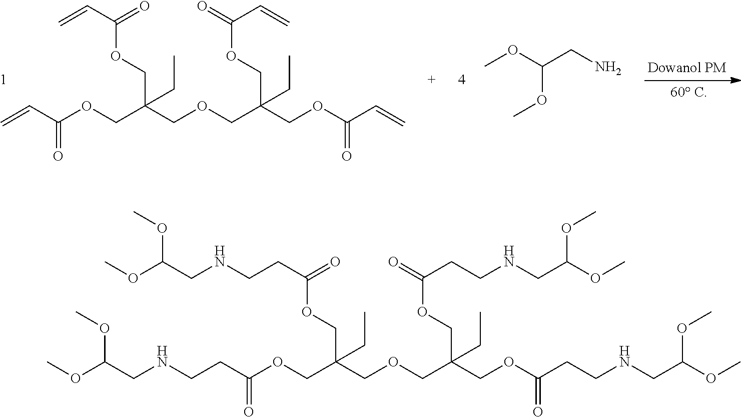

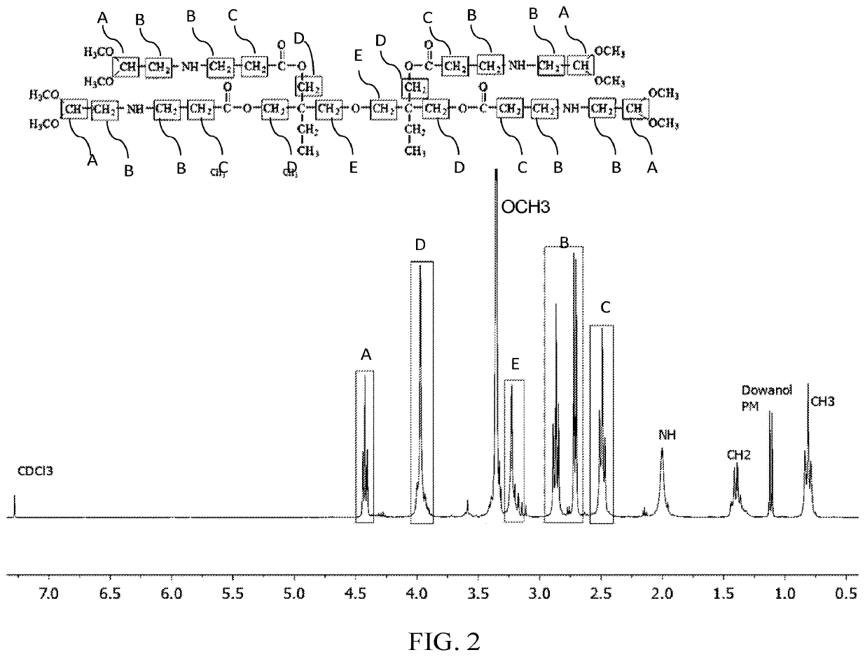

10 g (0.021 moles) of di(trimethylolpropane) tetraacrylate, 9 g (0.086 moles) of aminoacetaldehyde dimethyl acetal, and 19 g of DOWANOL™ PM were loaded into a 100 ml reaction vessel and the reaction mixture stirred at 50° C. for 10 hours. The resulting product was used as is without any further purification. The reaction product was obtained with a dry content of 50% yield. The product was analyzed by ¹H-NMR. The ¹H-NMR spectrum of the product is shown in FIG. 2.

### Example 5

Synthesis of Polyacetal from Trimethylolpropane Ethoxylate Triacrylate and Aminoacetaldehyde Dimethyl Acetal

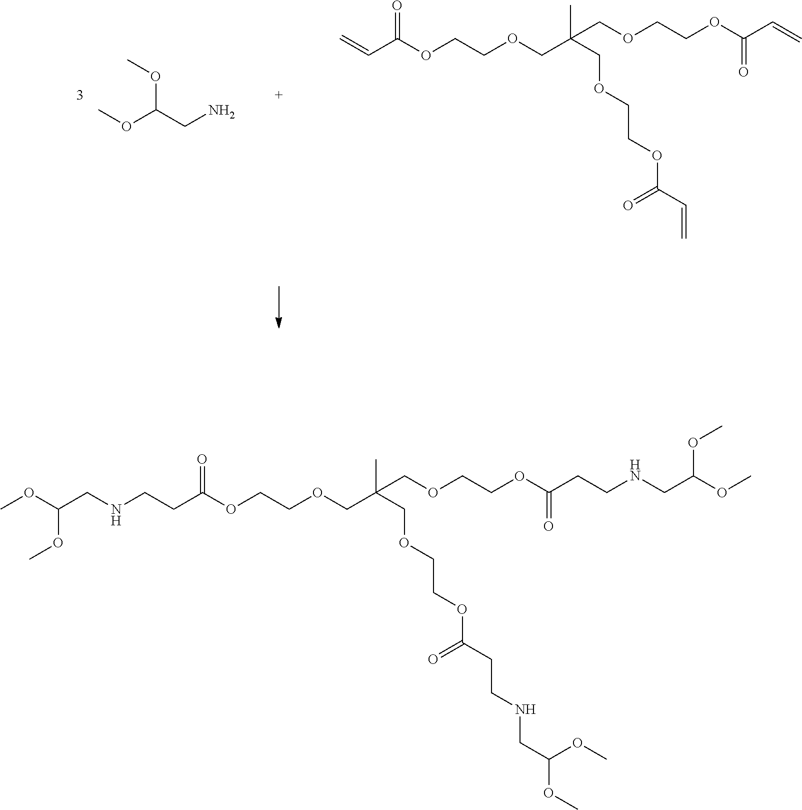

45.06 g of aminoacetaldehyde dimethyl acetal was loaded in a reaction vessel equipped with a condenser, a stirrer, and a temperature probe. 42.33 g of trimethylolpropane ethoxylate triacrylate was slowly added to the reaction vessel over ten minutes at room temperature to control the exotherm. The reaction mixture was then stirred at 60° C. for 6 hours.

### Example 6

Synthesis of Polyacetal from Bisphenol a Diglycidyl Ether (BADGE) and Aminoacetaldehyde Dimethyl Acetal

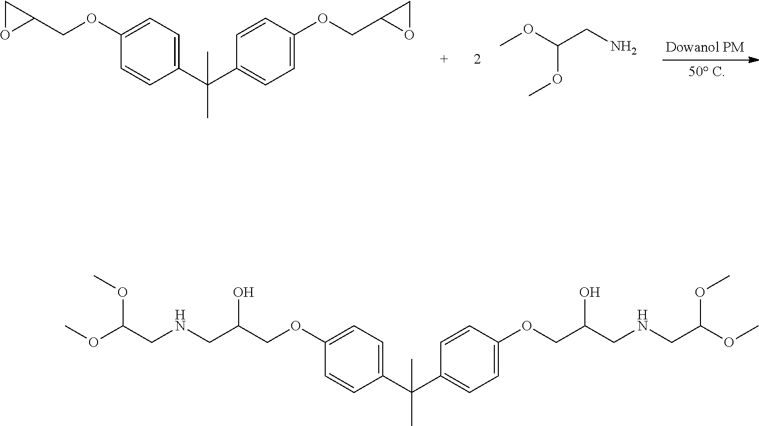

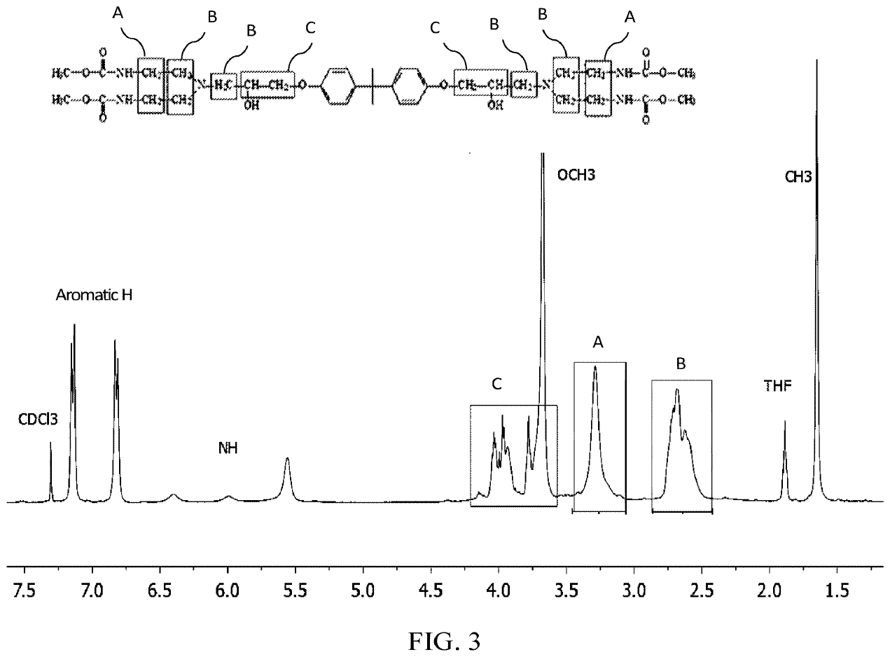

20 g (0.107 moles epoxy) of bisphenol A diglycidyl ether (BADGE), 11.44 g (0.109 moles) of aminoacetaldehyde dimethyl acetal and 31.4 g of DOWANOL™ PM were loaded into a 250 ml reaction vessel and the reaction mixture stirred at 50° C. for 10 hours. The resulting reaction mixture was used as is with a dry content of 50/o. The crude reaction product was analyzed by ¹H-NMR. The ¹H-NMR spectrum of the crude reaction product is shown in FIG. 3.

### Example 7

Synthesis of Polyacetal from Itaconate and Aminoacetaldehyde Dimethyl Acetal

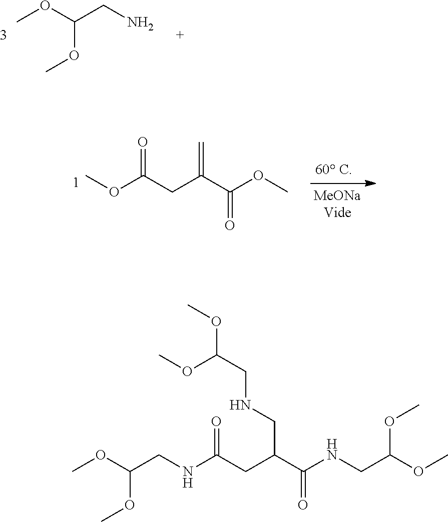

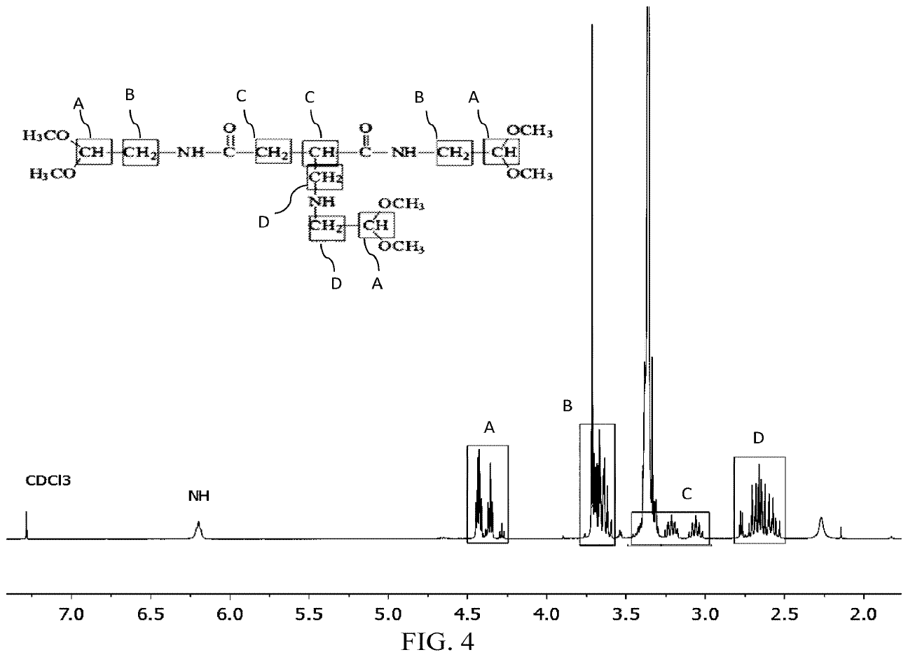

40 g (0.253 moles) of dimethyl itaconate and 79.8 g (0.253 moles) of aminoacetaldehyde dimethyl acetal were loaded into a reaction vessel and the reaction mixture heated to 60° C. while being stirred Once the temperature reached 60° C., 0.125 g (0.3 wt-%) sodium methoxide was added to the reaction vessel. The reaction vessel was then placed under vacuum of 120 mm Hg for 10 hours. The product is obtained as a pure viscous liquid and used as is, without any further purification. The crude reaction product was analyzed by ¹H-NMR and the spectrum is shown in FIG. 4.

### Example 8

Synthesis of polyacetal from imidazolidone and glyoxal dimethyl acetal

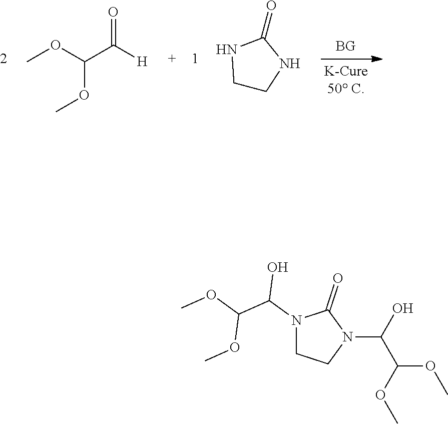

5 g (0.058 moles) of 2-imidazolidone and 9 g of DOWANOL™ PM were loaded into a 100 ml reaction vessel and the reaction mixture stirred at 50° C. until complete dissolution of 2-imidazolidone. Next, 20 g (0.115 moles) of glyoxal dimethyl acetal and 0.25 g of K-cure (1 wt-%) were added to the reaction vessel and the reaction mixture continued to be stirred at 50° C. for 10 hours. The product, with a dry content of 50%, is used as is, without any further purification.

### Example 9

Synthesis of Polyacetal from Polycyclocarbonate and Aminoacetaldehyde Dimethyl Acetal

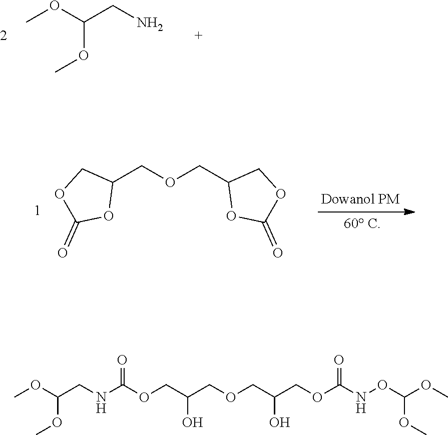

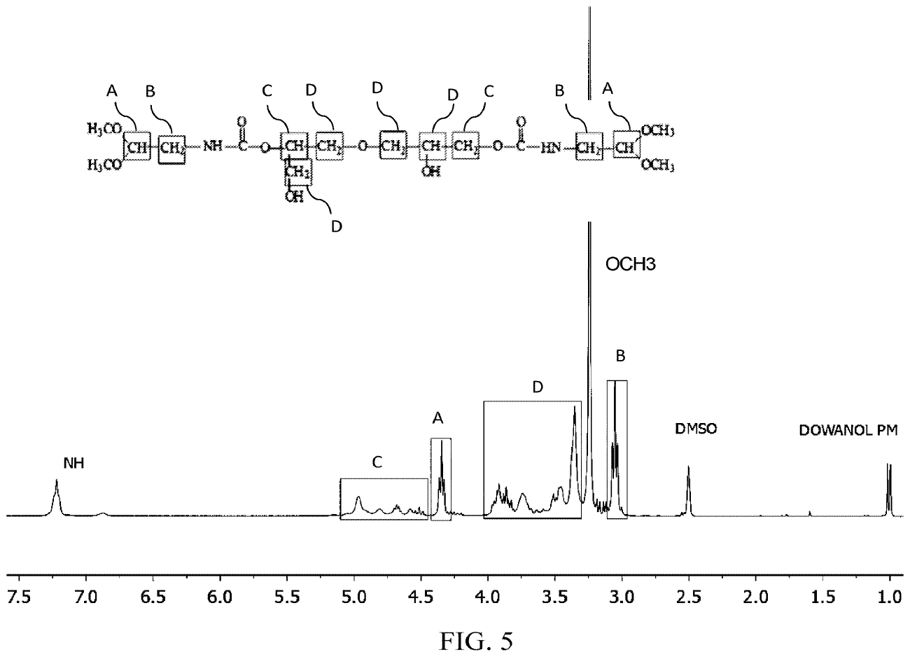

10 g (0.095 moles) of aminoacetaldehyde dimethyl acetal, 10.4 g (0.0478 moles) of diglycerol dicyclocarbonate, and 20.4 g of DOWANOL™ PM were loaded into a 100 ml reaction vessel and the reaction mixture stirred at 50° C. for 10 hours. The product, with a dry content of 50%, is used as is, without any further purification. The crude reaction product was analyzed by ¹H-NMR and the spectrum is shown in FIG. 5.

### Example 10

### Radical Copolymerization of Dimethyl Acetal Methacrylamide (Example 3) in Solvent Based Acrylic Resin:

168 g of butyl glycol was loaded into a reaction vessel equipped with a condenser, a stirrer, and a temperature probe, and stirred at 115° C. under an inert nitrogen atmosphere A mixture of 48.4 g of dimethyl acetal methacrylamide (from Example 3), 188.1 g of methyl methacrylate, 15.5 g of methacrylic acid and 7.56 g of TRIGONOX® 21S was slowly added to the reaction vessel over two hours at a constant rate. The reaction mixture was continued to be stirred at 115° C. for 4 hours, followed by the addition of 84 g of butyl glycol to reach a non-volatile component value of 50% As a result, an acrylic resin with an aldehyde equivalent weight of 901.5 on solid and an acid value of 40.1 was obtained.

### Example 11

Furanic dialdehyde was synthesized from 5,5′-[oxybis(methylene)]di-(2-furaldehyde).

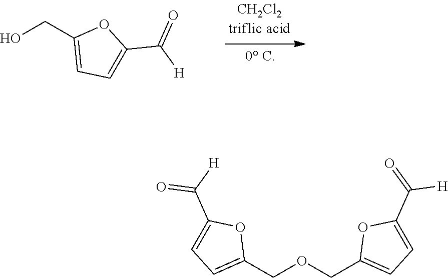 [SMILES: O=Cc1ccc(CO)o1 ; O=Cc1ccc(COCc2ccc(C=O)o2)o1]

10 g (0.079 moles) of hydroxymethyl furfural (HMF) and 100 ml of dichloromethane were loaded in a reaction vessel equipped with a condenser, a stirrer, and a temperature probe, and the mixture was stirred under an inert argon atmosphere. A mixture of 0.5 g trifluoromethanesulfonic acid (triflic acid) and 10 ml of dichloromethane was added dropwise to the reaction vessel at 0° C., maintaining the temperature at 0° C. during the addition. After completion of the reaction, the organic phase was washed with 100 ml water, followed by a second washing with 50 ml water. The resulting organic phase was dried on anhydrous sodium sulfate. After removal of solids via filtration, dichloromethane was removed by distillation, and the HMF was removed under vacuum. The resulting product was analyzed by ¹H-NMR. The spectrum showed that the product contained 5% residual HMF.

### Example 12

### Preparation of Hydroxymethyl Furfural (HMF) Methacrylate Monomers:

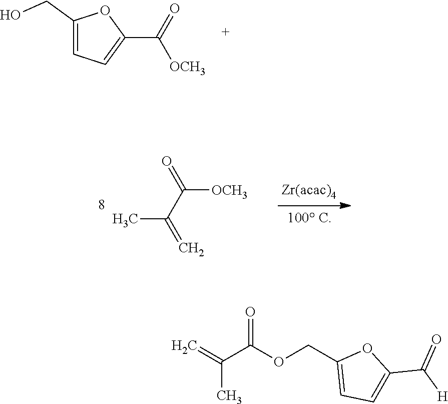

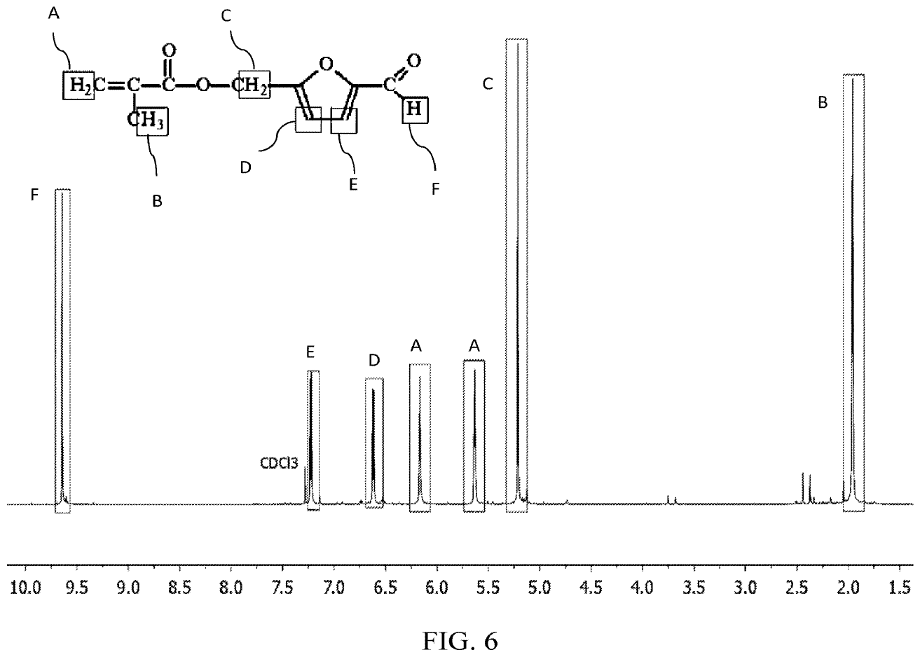

100 g (0.793 moles) of hydroxymethyl furfural (HMF), 635.1 g of methyl methacrylate, and 0.7 g (0.0032 moles) of hydroquinone were loaded into a reaction vessel equipped with a Dean-Stark receiver. The mixture was stirred at 100° C. for 30 minutes to remove water traces. 11.6 g of zirconium acetylacetonate was added to the reaction vessel and the reaction mixture stirred for 10 hours at 100° C. During this time the distillate containing the methanol from the Dean-Stark receiver was periodically removed. The reaction mixture was then distilled under vacuum at 10⁻² mbar and 70° C. temperature to remove the methyl methacrylate. The product was redissolved in dichloromethane and washed 3 times with a potassium bicarbonate solution in water. After a last wash with a saturated brine solution in water, the organic phase was dried with anhydrous sodium sulphate. After filtration to remove solids, the solvent was distilled under vacuum at 10⁻² mbar and 70° C. The reaction procedure as described furnished the product as a viscous brown liquid in 139 g (90%) yield. ¹H-NMR of the product helped characterize it as HMF methacrylate. The ¹H-NMR is shown in FIG. 6.

All references and publications cited herein are expressly incorporated herein by reference in their entirety into this disclosure, except to the extent they may ‘directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A coating system comprising:
an amide;
an aldehyde comprising two or more carbon atoms; and
a solvent.

2. The coating system of claim 1, wherein the amide is present at a molar ratio of 0.5 to 2.5 moles for every 1 mole of the aldehyde.

3. The coating system of claim 1, wherein the amide is represented by Formula (I): 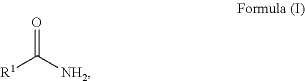
wherein R¹ is H or a carbon-containing group, optionally further substituted with one or more oxygen, nitrogen, or sulfur atoms or a combination thereof, preferably wherein R¹ is H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group.

4. The coating system of claim 1, wherein the amide comprises a diamide, triamide, or polyamide.

5. The coating system of claim 1, wherein the aldehyde is represented by Formula (II) or Formula (IIB): 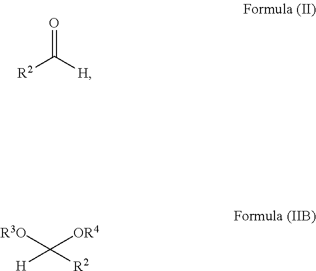
wherein R², R³, and R⁴ are independently a carbon-containing group, optionally further substituted with one or more oxygen, nitrogen, or sulfur atoms or a combination thereof, preferably wherein R², R³, and R⁴ are independently an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, optionally wherein the aldehyde is in a protected form comprising an acetal or a hydrate.

6-8. (canceled)

9. The coating system of claim 1, wherein the amide and the aldehyde form a reaction product represented by formula (III): 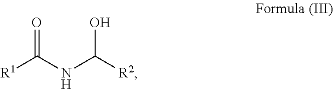
wherein R¹ is H or a carbon-containing group, optionally further substituted with one or more oxygen, nitrogen, or sulfur atoms or a combination thereof, preferably where R¹ is H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and
R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group.

10. The coating system of claim 1, wherein the amide and the aldehyde form a reaction product represented by formula (IV): 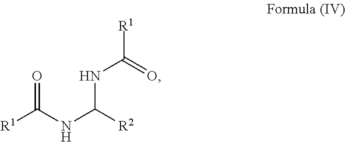
wherein each R¹ is independently H or a carbon-containing group, optionally further substituted with one or more oxygen, nitrogen, or sulfur atoms or a combination thereof, preferably where R¹ is H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and
R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group.

11. The coating system of claim 1, wherein the amide and the aldehyde form a reaction product represented by Formula (V): 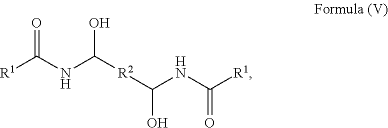
wherein each is independently H or a carbon-containing group, optionally further substituted with one or more oxygen, nitrogen, or sulfur atoms or a combination thereof, preferably where R¹ is H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and
R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group.

12. The coating system of claim 1, wherein the amide and the aldehyde form a reaction product represented by Formula (VI): 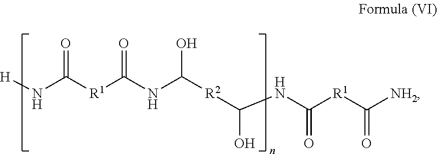
wherein each R¹ is independently H or a carbon-containing group, optionally further substituted with one or more oxygen, nitrogen, or sulfur atoms or a combination thereof, preferably where R¹ is H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and
R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group.

13. The coating system of claim 1, wherein the coating system is free or substantially free of formaldehyde and free or substantially free of isocyanate.

14. (canceled)

15. (canceled)

16. A coating system comprising a reaction product of:
an amide; and
an aldehyde comprising two or more carbon atoms.

17. The coating system of claim 16, wherein the reaction product is a crosslinked product of Formula (IV), Formula (V), or Formula (VI): 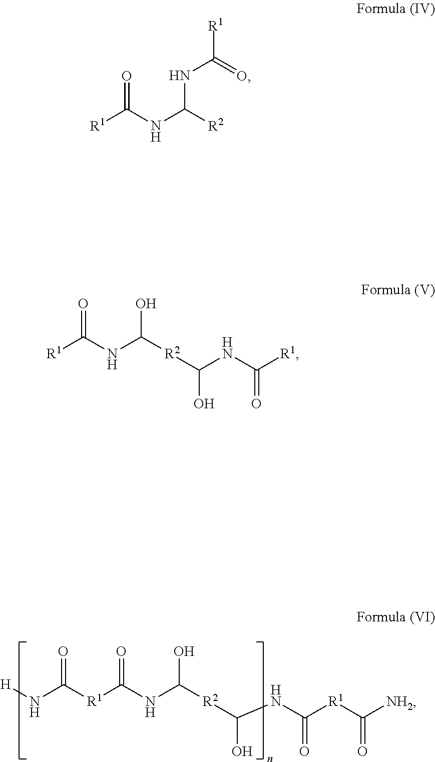
wherein each R¹ is independently H or a carbon-containing group, optionally further substituted with one or more oxygen, nitrogen, or sulfur atoms or a combination thereof, preferably where R¹ is H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and
R² is a carbon-containing group, optionally further substituted with one or more oxygen, nitrogen, or sulfur atoms or a combination thereof, preferably where R² is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group.

18. The coating system of claim 16, wherein the coating system is in powder form.

19. (canceled)

20. The coating system of claim 16, wherein the coating system is free or substantially free of formaldehyde and structural units derived from formaldehyde, and free or substantially free of isocyanate and structural units derived from isocyanate.

21. (canceled)

22. The coating system of claim 5, wherein the coating system is provided as a one-part coating, and wherein the aldehyde comprises a protected aldehyde.

23. The coating system of claim 22, wherein the protected aldehyde comprises an acetal or a hydrate.

24. The coating system of claim 1, wherein the aldehyde is a protected aldehyde comprising an acetal or a hydrate.

25. The coating system of claim 1, wherein the aldehyde comprises a polyaldehyde chosen from the group consisting of terephthaldehyde, glutaraldehyde, glyoxal, dimethoxy acetaldehyde, methylglyoxal, cyclohexanedicarbaldehyde, malondialdehyde bis(dimethyl acetal), 5,5′-(oxy-bis(methylene))bis-2-furfural, bis(dimethyl acetal) of imidazolidone, tetra-dimethyl acetal of glycoluryl, bis(dimethyl acetal) of polyglycidyl ether, tri(aminoethyl dimethyl acetal) of itaconic, tri(aminoethyl dimethyl acetal) of TMPEOTA, or poly(dimethyl acetal) of polycyclocarbonate.

26. (canceled)

27. The coating system of claim 24, wherein the protected aldehyde comprises a cyclic acetal.

28. An article coated with the coating system of claim 1.
